(19) United States
(12) Patent Application Publication
(10) Pub. No.: US 2023/0241516 A1
(43) Pub. Date: Aug. 3, 2023

(54) Method and System for Fantasy Sports Contest Based on Proposition Bets

(71) Applicant: Omer Salik, Hermosa Beach, CA (US)

(72) Inventor: Omer Salik, Hermosa Beach, CA (US)

(21) Appl. No.: 17/589,619

(22) Filed: Jan. 31, 2022

(51) Int. Cl. A63F 13/828; A63F 13/537; A63F 13/35

(52) U.S. Cl. CPC A63F 13/828; A63F 13/537; A63F 13/35

(57) ABSTRACT

Disclosed and claimed herein is a sports fantasy contest, wherein the roster for each fantasy team in the contest is a set of specific proposition bets for various players as opposed to a traditional point-based system for various performance metrics of the players in that roster. The system and method allows participants in the fantasy sports contest to create a fantasy sports team comprised of specific propositions for sports positions, provides odds for the selected parameters of those bets and determines the winner of the fantasy contest based on the results of those proposition bets.

### FIELD OF THE INVENTION

The present disclosure relates generally to a new fantasy sports system and method that is based on proposition bets.

### BACKGROUND OF THE INVENTION

The term “proposition bet” commonly refers to a bet made regarding the occurrence or non-occurrence during a game (usually a sports game) of performance condition not directly indicative of the game's final outcome. Proposition bets in sports are differentiated from the general bets for or against a particular team or contestant prevailing in a game/contest/match or regarding the total number of points scored. Traditionally, proposition bets can be made on performance conditions such as the number of strikeouts a pitcher will accumulate in a baseball game, whether a defensive player will score in an American football game, or which team will score the first points of the game.

There are currently many different types of fantasy sports competitions being played in a variety of sporting event categories. Of these, some of the most popular game methods of play associated with fantasy sports involve the team sports of football, basketball, baseball, soccer, and hockey. There is also an emerging market for esports fantasy competitions. Each of these existing game methods of play generally establish fantasy teams that are selected by the team owners which then compete against each other utilizing their selected team players as the basis for accumulating points on a periodic basis. In most instances, the accumulation of points occurs as the actual live players participate in actual live sporting events and achieve certain goals such as scoring points or accumulating other performance statistics associated with that particular sporting event.

One of the most common types of fantasy sports game involves fantasy football, based upon the actual games and actual players in the National Football League (NFL). Fantasy football is currently typically played over a seventeen game season, with games occurring on most or all weekends within the regular league season. Fantasy game players therefore compete against each other utilizing their selected fantasy team as a basis for accumulating points based on actual players' performances in the actual live sporting events.

More recently, competitions referred to as “daily fantasy” have become popular. Daily fantasy systems allow users to draft a new lineup of fantasy players weekly, daily or more frequently so that users are not locked into the same roster of fantasy players for an entire sport's season. In these systems, users also often have more flexibility as to who may be on their fantasy rosters than the traditional drafting system that only allows a single team owner to have a specific fantasy player on his or her team within a given league. Daily fantasy systems often run contests where the owner(s) compete for a cash pool on a daily or weekly basis with the winner being determined by the performance of the owner's fantasy team that day or week.

A drawback of traditional fantasy and daily fantasy contests and leagues is that the scoring system for the performance of a player is often complex and multi-variant. For example the performance of a football player may be measured by a point system seeking to approximate the player's holistic performance by ascribing value to one or more metrics of player performance, such as touchdowns scored, rushing yards, receiving yards, passing yards, carries, receptions, turnovers, field goals, tackles, sacks, fumbles, interceptions and so on. Some of the performance metrics, such as field goals, may only be applicable to certain positions. The metrics and the values assigned thereto can vary widely from league to league.

The complexity of the current fantasy scoring system distracts from and devalues the user's enjoyment of viewing games. For example, a user is likely to select for his or her fantasy team a player of which he or she is a fan. But even if that player performs well, which in spectating in the absence of fantasy team considerations would make the user happy (for example, by running for over 100 yards), yet the player failed, for example, to score a touchdown, the user would still be disappointed in the performance because it failed to yield a high fantasy point value.

An additional drawback of daily fantasy systems is that making selections that have low probabilities of success are not adequately incentivized. Daily fantasy contests often set virtual salary caps for a fantasy team with each player being assigned a virtual salary to count against the cap. The virtual salary of a player is generally based on the player's past and projected performance. In this way, users are rewarded for finding players that perform above historic averages and projected expectations, but the reward is diluted in the context of the complex scoring system and does not reflect the true probability of the user's selection. In addition, the limited number of roster spots on most fantasy leagues means most players are effectively excluded from being drafted in most leagues, limiting the breadth of appeal.

It would be desirable if a fantasy sports system and method could be developed and promoted that allowed users to assemble a fantasy team of players where the scoring for the team is based on one or more single performance metrics for a given player with the score awarded for the user's fantasy player and team being based on the probability of that performance metric being reached, such as in a proposition bet.

It would be desirable if a fantasy sports system and method could be developed that allowed users to bet on a combination of individual player performance and team performance.

It would be desirable if a fantasy user could change his bets multiple times, leading up to a game or during the game, and simply be credited or debited based on the updated odds of his prior bets. For example, if a user bets that an NBA team will score at least 100 points, and by halftime they have already scored 60 points, indicating a high probability that his bet will succeed, the user can “cash in” that bet at an appropriate payout and use the proceeds to place a new bet.

### SUMMARY OF THE INVENTION

Embodiments that fulfill the above and other objectives provide a system and method for carrying out a fantasy sports game where the composition of team and scoring thereof is based on a user's selection of a set of proposition bets as opposed to a set players. In an embodiment of such a fantasy contest, a user must fill n slots for his or her fantasy team with n proposition bets. The collective performance of those n proposition bets are used to measure the user's performance against other users' teams to determine the winner of the contest or league.

Embodiments further comprise a fantasy scoring system and method that is based on a probability of the proposition bet selected by the user. In such embodiments, proposition bets selected by the user having a lower likelihood of success yield a higher fantasy point value than proposition bets having a higher likelihood of success.

In other embodiments, a user may be given a fixed amount of virtual or real currency or cryptocurrency to place any number of proposition bets. In such embodiments, the fantasy contest winner may be determined by the performance of the user's overall return on his or her proposition bets using the virtual currency. In embodiments, proposition bets based on something other than a player performance metric may also be selected by the user.

In other embodiments, a user's fantasy betting account can be linked to an actual betting account, and the user can select which of his fantasy bets to convert into actual bets.

In other embodiments, fantasy bets can be placed across multiple sports leagues, broadening the appeal of the system.

In other embodiments, fantasy proposition bets can be combined or parlayed with multiple “AND” or “OR” conditions to increase or reduce their payout. For example, the probability of the Lakers winning the NBA Championship AND the Rangers winning the NHL Championship is lower than either condition happening alone.

In other embodiments, fantasy proposition bets can be changed multiple times, at appropriate payout levels, leading up to or during the game.

### BRIEF DESCRIPTION OF THE FIGURES

FIG. 1 is a diagram depicting one or more embodiments of a system for implementing a fantasy sports competition based on proposition bets.

FIG. 2 is a diagram depicting a user interface for one or more embodiments of an application for implementing a fantasy sports competition based on proposition bets.

FIG. 3 is a flow diagram depicting the function flow for a user interface for one or more embodiments of an application for implementing a fantasy sports competition based on proposition bets.

FIG. 4 is a flow diagram depicting the function flow for a server process for one or more embodiments for implementing a fantasy sports competition based on proposition bets.

FIG. 5 is a flow diagram depicting the function for an embodiment for determining and displaying the odds of selected prop bet parameters by a user.

### DETAILED DESCRIPTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purposes of clarity, details relating to technical material that is known in the technical fields related to the invention have not been described in detail so as not to unnecessarily obscure the present invention.

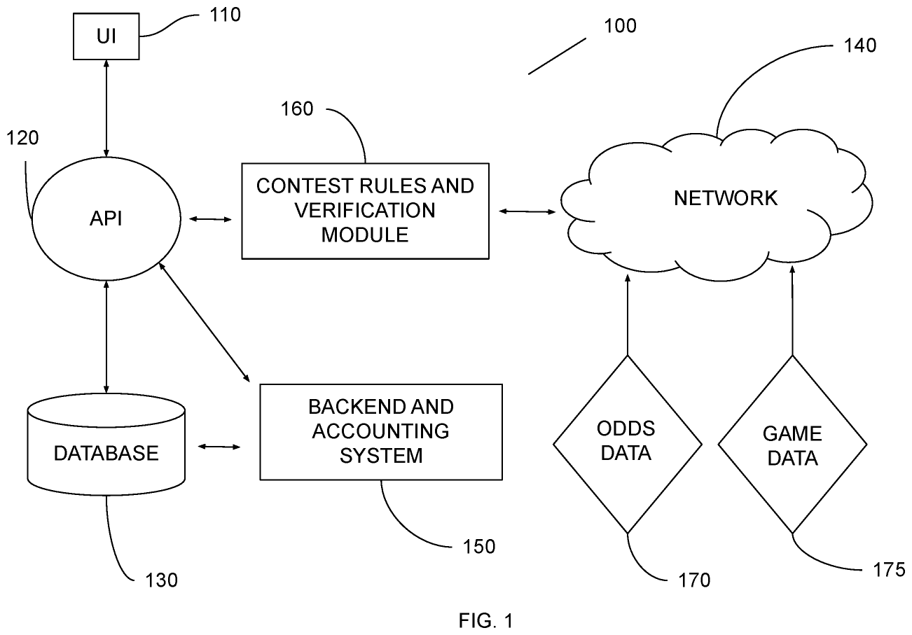

FIG. 1 depicts a system 100 configured to provide a fantasy proposition contest system. System 100 allows a user to create his own set of customized fantasy proposition bets on a wide range of performance conditions that may occur during an event, such as a sporting event, automatically generates the odds to offer the user for the customized set of fantasy proposition bets, automatically verifies the results of the fantasy proposition bets and then automatically scores the set of fantasy proposition for the participants in the contest to determine a winner of the contest.

A proposition bet or “prop bet” is a bet relating to an occurrence or non-occurrence of some performance condition during an event. For example, during a sporting event, a “prop bet” may relate to the occurrence or non-occurrence of a statistical performance of one of the players or a comparative statistical performance of two or more players, without direct regard to the sporting event's final outcome. Furthermore, a “prop bet” can span multiple related or unrelated performance conditions. For example, a “prop bet” may include predicting a number of points scored by a player over a series of games, regardless of the actual outcome of any one of the games.

User interface (UI) 110 of the system enables the user to construct a customized fantasy “team” comprised of proposition bets. As one example in the context of sporting events, the user can select a particular sport (e.g. football, basketball, baseball) and league (e.g. NFL, NBA, MLB). The user can then select one or more players whose performance statistics will form the basis of one or more prop bets. The system may present a player selection interface that enables the user to browse by event, team, position, or word search. For example, the user can first be presented with the option to select a particular team, which enables the user to then select the team itself or one or more players from a displayed team roster. According to another option, the user can be presented a list of upcoming sporting events, possibly sorted by time or filtered according to certain teams. The user can then select the relevant sporting event and then one or more players from a displayed roster of players participating in the selected event(s). Various other filters and sorting options can be presented.

To further enable the user's creation of a fantasy team based on prop bets, the system may also present the user with one or more interfaces that display bet customization options. For example, the bet customization choices may include: the type of bet (e.g. single statistics, combined statistics or head-to-head comparison); the performance statistic relevant to a specific position (e.g. passing yards for a football quarterback); and performance conditions (e.g. more than/less than a performance threshold or another player).

For sports where players are categorized by position and statistics that are position specific (e.g., the NFL), the system will map statistics and make only the relevant ones available based on the player selected. In this context, if a quarterback is selected first, for example, only quarterback players will be available for selection as either a combined or head-to-head bet. Input values may also have min/max validations based on the statistic selected.

The system 100 includes a database 130, including teams, players, sporting events, rosters of players, statistical categories, etc. that support generation of the display screens for constructing the fantasy team. Database 130 also stores fantasy teams and related prop bets created via user interface 110, as well as information used to verify the outcome of the fantasy contests.

Application programming interface (API) 120 serves as an interface between user interface 110 and backend elements, such as database 130, backend and accounting system 150 and contest rules and verification module 160. For example, API 120 populates the fields of user interface 110 through one or more function calls that retrieve data from database 130 and for display and use at user interface 110. Contest rules and verification module 160 provide API 120 for display to UI 110 available fantasy sports contests, challenges and leagues available and their associated rules.

In embodiments, contest rules and verification module 160 may retrieve information from external data sources, including for example odds data 170 regarding the odds for certain prop bets that may comprise a user's fantasy team through network 140. Contest rules and verification module 160 may also aggregate and average those odds or determine their median. API 120 displays the contest rules for a fantasy contest through API 120 with the associated odds of various prop bets that may comprise a user's fantasy team received from content rules and verification module 160.

In other embodiments, contest rules and verification module 160 generates odds independently of external odds data sources. In such embodiments, contest rules and verification module 160 may generate a “predicted” score for the player for a specific statistic based on game data 175 for past events. This predicted score computation may be performed by analyzing the player's historical statistical performance. For example, data illustrating the player's historical performances may be retrieved from game data 175 via network 140 or from database 130. In one approach a player's ten game moving average for a certain statistical performance can be used to predict the player's performance in the next game. The volatility of that average can also be calculated over that time period to determine the probability of the player achieving the selected numeric value of the prop bet statistic based on the player's risk-weighted expected performance model. Other factors, such as weather and opponent may also be used to further refine prediction. This probability may then be used to set the odds for the numeric value of the performance statistic selected by the user. Once calculated, the odds are transferred from API 120 to user interface 110, where the user has the option of accepting or declining the odds and bet as a component of his or her fantasy team. In order to ensure up-to-date data in database 130, database 130 receives updated information via network 140. Data from data sources are downloaded over network 140, parsed and ultimately transmitted to database 130. In another approach, actual sportsbook odds for certain proposition bets can be used to help determine the fantasy odds for those bets. In another approach, the system can include a “market” for certain proposition bets, in which users bid on the right to place those bets, which can help determine the payouts for those bets. These payouts can be continuously updated leading up to or during a game, in case users want to cash in or change their bets.

System 100, through contest rules and verification module 160 and game data 175 via network 140, may also verify the performance of a user's fantasy teams. An external data provider providing game data 175, such as a statistics provider, maintains a real time or near real time database of performance statistics for all sporting events from which prop bets can be created. Contest rules and verification module 160 queries game data 175 and compares that data to the contest rules and prop bets comprising users' fantasy teams stored in database 130 to verify and determine the performance of users' fantasy teams in real time or near real time.

Contest rules and verification module 160 periodically runs a process to determine whether any bets may be verified using parsed data. This process is essentially performed by comparing the customized proposition bets comprising each fantasy team and statistical performance threshold with the live player statistical value parsed by the system. If the outcome can be determined from this comparison, then the prop bet is automatically verified at that point in time, resulting in fantasy team results being verified during live sporting events as play unfolds. At the completion of a sporting event, contest rules and verification module 160 receives final “box score” data to come through from game data 175 to resolve any outstanding fantasy team results. Also included in system 100 is backend and accounting system 140, which may provide financial and administrative functions for executing fantasy transactions for API 120.

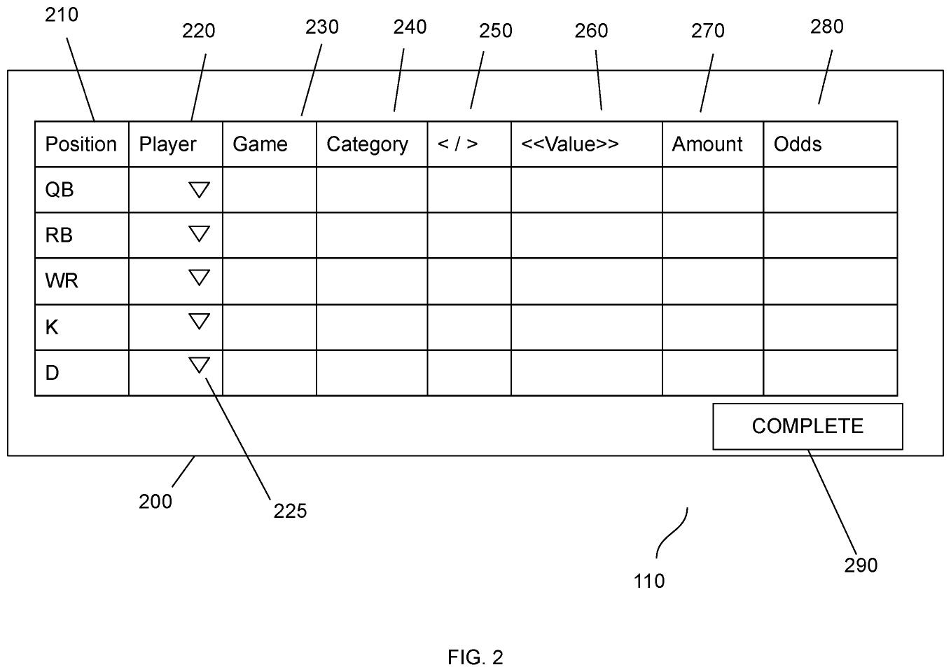

FIG. 2 depicts an embodiment of a user interface 110 for display on a screen 200 for receiving a user's input for a fantasy team comprised of propositions. As with other fantasy teams, the user's fantasy team is comprised of various positions 210 on a team. In the example show, the positions 210 of a football team, e.g. quarterback (QB), running back (RB), wide receiver (WR), kicker (K) and defense (D), are displayed. For each position 210, the user is prompted to select a player 220. A drop down list 225 of players 220 may be provided. In alternative embodiments, text entry and search functionality may also be provided. Depending on the contest rules, the game 230 in which the player 220 is participating may be automatically selected by the system or game 230 options may be presented to the user for selection. For example, if the fantasy contest is restricted to games on a certain day or a given week, there may be only one game 230 for each player 220 from which to select, in which case, the system may automatically display the game 230 for a selected player 220. If, however, the rules of the fantasy contest allow for more than one game 230 to be selected for a given player 220, the user may select the game 230 in which the player 220 performance for the proposition bet will be selected by the user.

In the embodiment shown in FIG. 2, the user may also select the statistical category 240 for the proposition bet for the given player 220 in a given game 230. In the embodiment shown for a football fantasy team, the category may be among a group of common statistical categories for each position 210. For example, for an offensive position 210, the user may select from a category 240 defined by a set of offensive performance metrics, such as passing yards, rushing yards, receiving yards, passing touchdowns, receiving touchdowns, rushing touchdowns, kicked field goals, fumbles and interceptions among other statistical categories. Similarly a defensive team or position can have a category 240 selection defined by a set of defensive metrics, such as points allowed, rushing yards allowed, passing yards allowed, fumbles, interceptions, and safeties among other statistical categories. The user may then select whether the player 220 in a particular game 230 will achieve a statistical outcome greater or less than 250 a specified value 260. For example, a user may wish to select that a given running back will rush for more than 100 yards. In certain embodiments, depending on the fantasy contest rules, the user may be presented with an amount 270 to place on the specific proposition. In other embodiments, the amount placed on each proposition may be fixed or otherwise predetermined by the system. Depending on the player 220, game 230 and greater/less than 250 the specified value 260 parameters, odds 280 are presented to the user for those selections. The user may then alter the parameters to find a proposition that has higher or lower odds 280. In certain embodiments, the potential payout for a proposition is also displayed based on the amount 270 and odds 280 for a given proposition parameters. Once the user selects a proposition for each position, the user's team selection for that contest may be completed by pressing the complete 290 button.

In certain embodiments, the user may select a proposition bet that has a binary outcome. For example, the proposition bet may be whether that player scores the first points of the game For such proposition bets, the greater/less than 250 field may be grayed and the specified value 260 field may be 1 (for yes) or 0 (for no). In other embodiments, the user may also select team-based proposition bets, such as which team will win the coin toss, score the first point, commit the first turnover or other similar binary events. For embodiments of contests where the user is allowed to place such team-based proposition bets, the user interface may be modified.

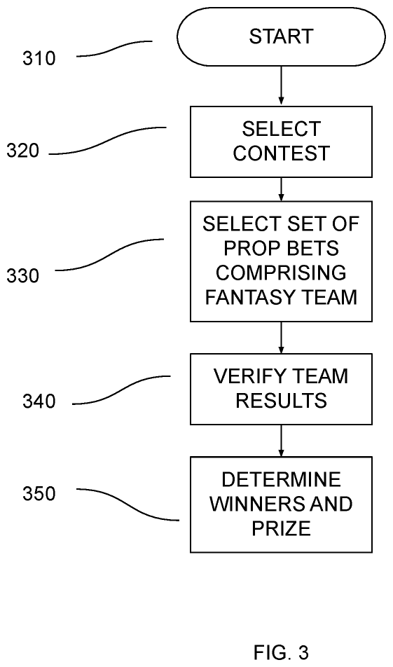

FIG. 3 depicts a flowchart of an embodiment for a user interface for a fantasy sports contest based on proposition bets. The process starts 310 and then awaits the user to select the contest 320 the user wishes to enter into. In the Select Contest 320 step, the user may select a contest based on the sport and the contest rules. The contest rules define the essential elements of the fantasy sports contest, such as the number and type proposition bets required to be selected to complete a fantasy team, the number of participants, the price for entering the contest, the rules for determining the winner and the payouts for winners of the contest. Other contest rules may also be imposed. Once the user selects the contest 320 he or she wishes to participate in, the user is prompted to select his or her team 330 through the selection of one or more proposition bets that will comprise his or her team. For example, if the user may have selected to participate in a fantasy contest for the sport of football that requires that a proposition bet be placed for specific positions, such as quarterback, running back, tight end, wide receiver and kicker. The user must then select the set of proposition bets comprising his or her fantasy team 330 by selecting an eligible proposition bet (as defined by the contest rules) for a specific quarterback, running back, tight end, wide receiver and kicker. This may be implemented through a user interface such as that depicted and described in FIG. 2. Once the user has selected the set of proposition bets comprising his or her fantasy team 330, the results of the user's proposition bets are verified based on the outcome of the games for each of those proposition bets. In this way, the user's team results are verified 340. Once each of the fantasy team results participating in the contest are verified, one or more winners are determined 350 based on the contest rules.

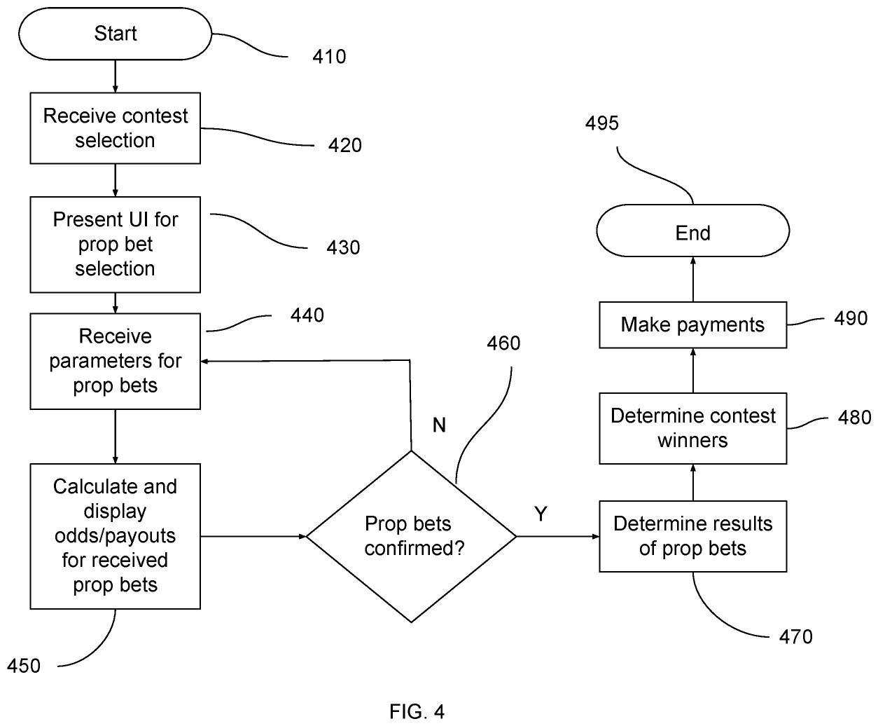

FIG. 4 depicts a flowchart of an embodiment for a server process to facilitate a fantasy sports competition based on a set of proposition bets. The process starts 410 and the server receives from the user a contest selection 420. Based on the fantasy contest selected by the user 420, the server sends instructions to present the user interface (UI) for the user's selection of prop bets 430 as set forth by the rules of the contest selected by the user 420. The server receives the one or more fields setting forth the required parameters for prop bets 440, an example of which is depicted in FIG. 2. The server calculates and causes the display of the odds and payouts for the different prop bet parameters selected by the user 450. This process continues until all the prop bets by the user are confirmed 460. When the prop bets by the user are confirmed 460, the server then determines the results of the prop bets 470 selected by the user as the underlying games are played or thereafter. Once the prop bets for each of the users participating in a contest are determined, the server determines the winner of the contest 480 and makes payments 490 to the winners based on the contest rules, which ends the process for a particular fantasy contest 495.

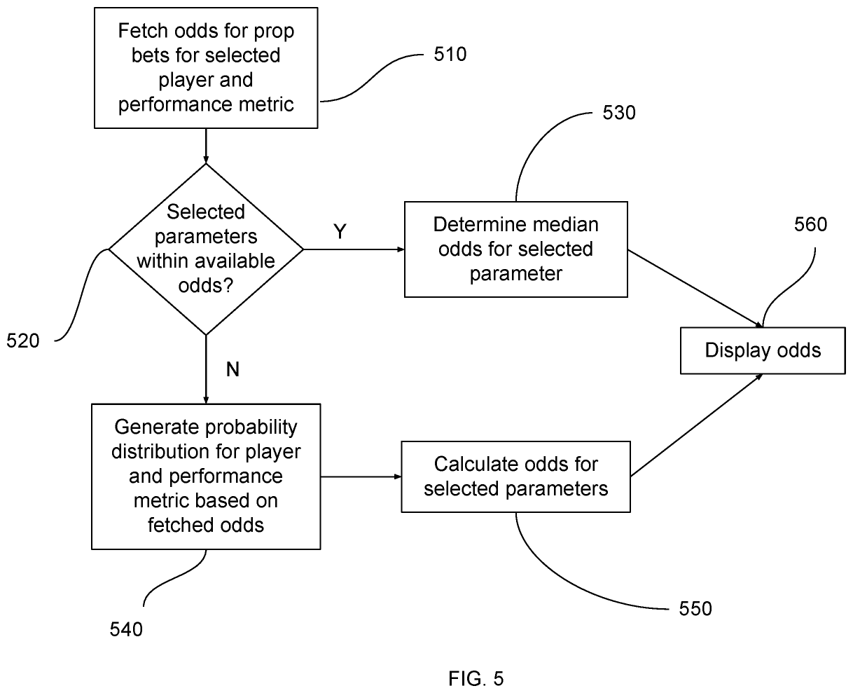

FIG. 5 depicts a flowchart for an embodiment for calculating and displaying the odds and payouts for the different prop bet parameters selected by the user 450. The system fetches odds for prop bets 510 that are the same or similar to the parameters selected by the user for a particular prop bet. For example, the system may fetch prop bet data from the databases of sports books or other historic or predictive data from other sources, such as news or fantasy sports sources. The system may fetch such data for the specific player and performance parameter selected by the user, if available. The system may also fetch related data, such as other related performance parameters for that same player, data relating to the same performance parameter for that player in similar conditions in the recent past, or data relating to the same performance parameter for other players.

If the selected parameters of the user are within the available odds from outside databases 520, the system may use those fetched odds to determine a median odds for the selected parameters 530 and display those odds 560. If, however, the user has selected prop bet parameters that are not within the odds available from outside databases 520, the system may use the fetched data 510 to generate a probability distribution for the prop bet parameters the user has selected. For example, if the fetched data indicates the over/under even odds prop bet for a specified quarterback in a specific game to pass for more than 200 yards, the but the user has entered a prop bet parameter that has that quarterback passing for more than 500 yards in that game, the system may assume a normal distribution of probabilities with a median of 200 yards and a standard deviation of, for example, 100 yards. Based on generated probability distribution 540, the system may then calculate the appropriate odds for the selected parameters 550. For example, if the has selected a prop bet that has that same quarterback passing for more than 500 yards in that game, the system may calculate that the probability of that is 2 standard deviations above the median and therefore has a probability of 0.1%. A normal distribution and the probabilities associated with each standard deviation is depicted below:

In other embodiments, different probability distributions may be used derived from the historic data for that player, that position, the opponent, physical conditions (e.g. field, weather) and other relevant factors. In calculating the odds for the selected parameters 550, the system may also consider other factors besides the generated probability distribution 540, such as injuries for either team, any movement of the available prop bets, importance or prominence of the game, or other statistical factors. In other embodiments, the odds of the selected parameters may be calculated directly without generating a probability distribution. In other embodiments, the system can include a “market” for certain proposition bets, in which users bid on the right to place those bets, which can help determine the payouts for those bets.

In embodiments, the system ensures that a selected prop bet parameter provides the same odds for any player selecting that parameter so as to ensure consistency across the fantasy contest. In this way, the accuracy of the odds for a particular prop bet selection is less impactful than in providing traditional prop bets, because it is only a single prop bet within a broader set of prop bets comprising a fantasy team of multiple prop bets. Thus, if the system overestimates or underestimates the odds and payout for one or more prop bets, but applies those odds consistently to any contest participant, the impact of the miscalculation is mitigated and the system is not put at risk for providing poorly calculated odds with significant risk of loss.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

What is claimed is:

1. A method for implementing a fantasy sports contest, comprising the steps of:
presenting to a user device parameters defining said fantasy sports contest, said parameters defining at least the set of roster positions from a sport and an organization of the sport upon which said fantasy contest is based, wherein said set of roster positions will constitute a user's fantasy team for competing in said fantasy sports contest, wherein said parameters further define the rules for determining winner of said fantasy sports contest, wherein said parameters further define a set of sporting events in said sport and organization available for said fantasy sports contest in selecting said roster positions;
receiving from one or more users a selection indicating a desire to enter said fantasy sports contest;
for each said roster position, receiving from a user parameters for a proposition bet, said parameters including a player in said sport and organization, a sporting event in which said player in said sport and organization will play, a performance metric for said player in said sporting event, and a value for said performance metric that said player in said sporting event will exceed or fail to exceed;
calculating the odds for said received parameters for said proposition bets,
receiving data related to said sporting event and determining the result of said received proposition bets comprising said user's fantasy team;
identifying the winner of said fantasy sports contest based on said determination of results of said received proposition bets and said rules for determining winner.

2. The method of claim 1 further comprising the step of:
receiving from the user an amount of money for each said proposition bet.

3. The method of claim 2 further comprising the step of:
presenting to the user the payout for each said proposition bet based on said odds and said received amount of money.

4. The method of claim 3 further comprising the step of:
calculating to total winnings of each user in said fantasy sports contest based said determination of results of said received proposition bets.

5. The method of claim 1 further comprising the step of:
fetching sports betting lines from one or more external databases for use in said calculating the odds for said received parameters for said proposition bets.

6. The method of claim 5 further comprising the step of:
determining if a betting line obtained from said fetching corresponds to said parameters for a proposition bet, and
if a betting line obtained from said fetching does correspond to said parameters for a proposition bet, using said betting line for calculating the odds for said received parameters for said proposition bets, but if a betting line obtained from said fetching does not correspond to said parameters for a proposition bet, generating a probability for said received parameters for said proposition bets based on said betting lines for calculating the odds for said received parameters for said proposition bets.

7. A sports fantasy game wherein each user has a fantasy team, said sports fantasy game comprising:
a roster of fantasy players for each said fantasy team, said fantasy players corresponding to athletes participating in a sport;
said fantasy team further being defined by a proposition bet selected by each user for each fantasy player in said user's roster, said proposition bet being defined by a value for a performance metric that said athlete will exceed or not exceed in a specified event of said sport,
wherein each proposition bet is assigned odds based on probability that said proposition bet will win or lose; and
wherein the winner of said fantasy game is determined by the outcome of said proposition bets and corresponding odds for said proposition bets.

8. A sports fantasy game as claimed in claim 7, further comprising:
each said proposition bet defining said fantasy team has an equal amount of money at stake.

9. A sports fantasy game as claimed in claim 7, further comprising:
each said has a fixed sum of money to distribute against each said proposition defining said fantasy team, and said user designates the amount of money from said fixed sum to place on each said proposition bet,
wherein the payout for each said proposition bet is calculated based on said designated amount of money and said odds and used to determine said winner.

10. A sports fantasy game as claimed in claim 7, further comprising:
said assigned odds for a proposition bet is the same for each user participating in said sports fantasy game.

11. A sports fantasy game as claimed in claim 7, further comprising:
said assigned odds for a proposition bet is calculated independently for each user.

12. A sports fantasy game as claimed in claim 7, further comprising:
awarding said winner with prize money associated with said fantasy sports contest.

13. A system for implementing a fantasy sports contest, comprising:
a first user interface for presenting a selection of fantasy sports contests, each presented fantasy sports contest being defined by a set of parameters comprising the set of roster positions from a sport and an organization of the sport upon which said fantasy contest is based, wherein said set of roster positions will constitute a user's fantasy team for competing in said fantasy sports contest, wherein said parameters further define the rules for determining a winner of said fantasy sports contest, wherein said parameters further define a set of sporting events in said sport and organization available for said fantasy sports contest in selecting said roster positions;
said first user interface further receiving from a user an input to enter into a fantasy sports contest;
a second user interface for receiving from said user inputs for selecting said roster positions and proposition bets for each said roster position constituting said user's fantasy team for competing in said fantasy sports contest, wherein said inputs for selecting said roster positions and said proposition bets include at least (i) a selection of a player participating in said set of sporting events in said sport and organization available for said fantasy sports contest, (ii) a specific sporting event within said set of sporting events, (iii) a performance parameter for said player in said specific sporting event, (iv) a numeric value for said performance parameter, and (v) an indication of whether said player in said sporting event will obtain greater or less than said numeric value for said performance parameter;
a probability calculator for fetching data predictive of said performance parameter for said player and determining the odds of the proposition bet for each said roster position based;
a contest verification module for fetching data related to performance of said player in said sporting event and determining the outcome of each said proposition bet for each said roster position.

14. The system of claim 13 further comprising a database for maintaining historic performance data for active players in said organization of the sport.

15. The system of claim 14 further comprising a payment module for receiving payments from users and sending payments to winners of said fantasy sports contest.
